(19) United States
(12) Patent Application Publication
(10) Pub. No.: US 2026/0333154 A1
(43) Pub. Date: Oct. 22, 2026

(54) DEVICES, METHODS, AND SYSTEMS FOR RLM AND BFD FOR L1/L2 MOBILITY

(71) Applicant: InterDigital Patent Holdings, Inc., Wilmington, DE (US)

(72) Inventors: Martino Freda, Laval (CA); Keiichi Kubota, Setagaya-Ku (JP); Oumer Teyeb, Montreal (CA); Brian Martin, Farnham (GB); Paul Marinier, Brossard (CA)

(73) Assignee: InterDigital Patent Holdings, Inc., Wilmington, DE (US)

(21) Appl. No.: 18/997,959

(22) PCT Filed: Aug. 1, 2023
(86) PCT No.: PCT/US2023/071433

§ 371 Date: Jan. 23, 2025

Related U.S. Application Data
(60) Provisional application No. 63/395,242, filed on Aug. 4, 2022.

(51) Int. Cl. H04W 36/00; H04W 12/08; H04W 36/04; H04W 36/30; H04W 76/20; H04W 80/02

(52) U.S. Cl. CPC H04W 36/00835; H04W 12/08; H04W 36/0058; H04W 36/04; H04W 36/302; H04W 76/20; H04W 80/02

(57) ABSTRACT

A wireless transmit/receive unit (WTRU) may determine to perform RLM on a subset of the set of candidate cells for at least the time period after receiving a message, may determine to terminate RLM on the subset of the set of candidate cells once the time period after receiving the message has passed, may determine to report at L1/L2 measurements associated with the RML performed on the subset of the set of candidate cells, may receive a handover command toward a first candidate cell from the subset of the set of candidate cells, and may determine to perform RLM on the first candidate cell in accordance with the configuration information for the RLM for the serving cell based on receiving the handover command.

### CROSS-REFERENCE TO RELATED APPLICATIONS

This application claims the benefit of U.S. Provisional Application No. 63/395,242, filed on Aug. 4, 2022, the entire contents of which are incorporated herein by reference.

### BACKGROUND

Using L1 bean measurements to make mobility decisions may allow a network to move a WTRU to the best cell more quickly than L3 measurements (e.g., RSRP) and may help ensure that the WTRU is always served by the best cell/beam. However, quick handover decisions may require the WTRU to determine whether a candidate cell is an acceptable target to avoid handover failures due to temporary fades that may occur just before the handover. Also, the WTRU may not reliably send L1/L2 measurements to the serving cell if the serving cell quality has already started to deteriorate. To help reduce the latency of the mobility procedure, the L1/L2 mobility command may come from a target cell itself.

What is needed are candidate cell RLM/RLF procedures performed by the WTRU for a period of time following network indication depending on serving cell measurements. This disclosure pertains to devices, methods, and systems for performing radio link monitoring (RLM) and beam failure detection (BFD) procedures for L1/L2 mobility.

### SUMMARY

A wireless transmit/receive unit (WTRU) may comprise a processor. The processor may be configured to receive a radio resource control (RRC) message comprising configuration information for radio link monitoring (RLM) of a serving cell and a set of candidate cells, the configuration information comprising an indication of a time period for RLM for the set of candidate cells and a reference signal received power (RSRP) threshold for the serving cell. The processor may be further configured to receive a message that indicates that RLM is to be initiated for at least a subset of the candidate cells using the configuration information for the RLM for the set of candidate cells indicated in the RRC configuration information. The processor may be further configured to determine to perform RLM for the subset of the set of candidate cells for at least the time period after receiving the message. The processor may be further configured to determine to terminate RLM for the subset of the set of candidate cells once the time period after receiving the message has passed. The processor may be further configured to determine to report at L1/L2 measurements associated with the RML performed on the subset of the set of candidate cells. The processor may be further configured to receive an L1/L2 handover command toward a first candidate cell from the subset of the set of candidate cells. The processor may be further configured to determine to perform RLM on the first candidate cell in accordance with the configuration information for the RLM for the serving cell based on receiving the L1/L2 handover command.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a procedure diagram illustrating an example New Radio (NR) handover scenario.

FIG. 3 illustrates an example L1/L2 inter-cell mobility operation using carrier aggregation (CA).

FIG. 4 illustrates example RLM and RLF detection mechanisms.

FIG. 5 is a diagram illustrating an example call flow of L1/L2 inter-cell mobility operation based on L1/L2 measurements.

### DETAILED DESCRIPTION

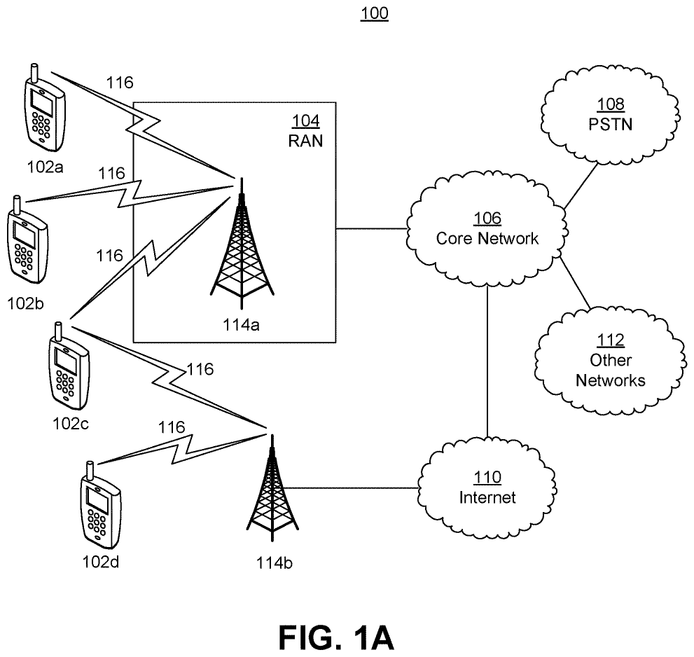

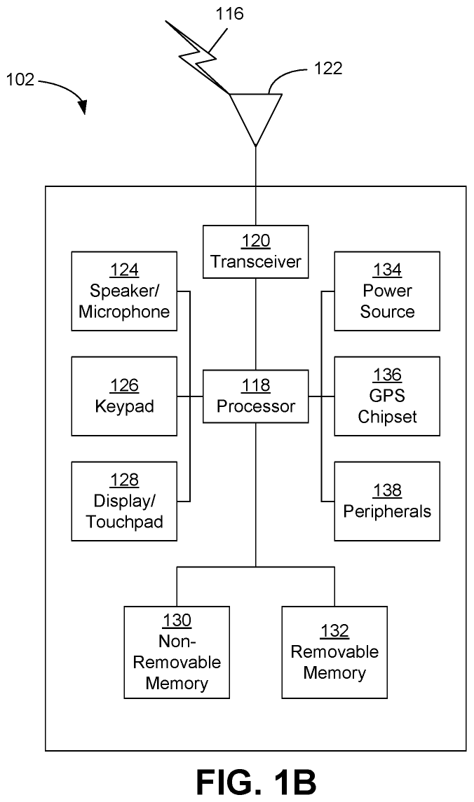

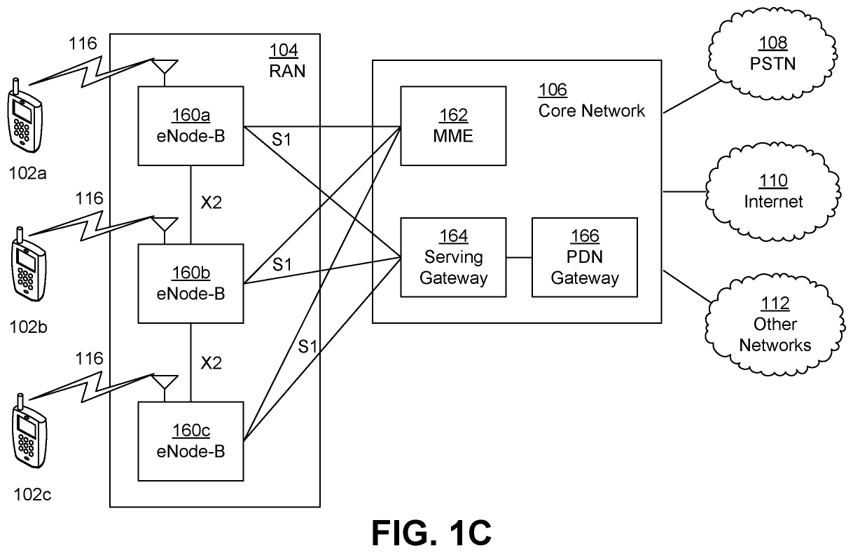

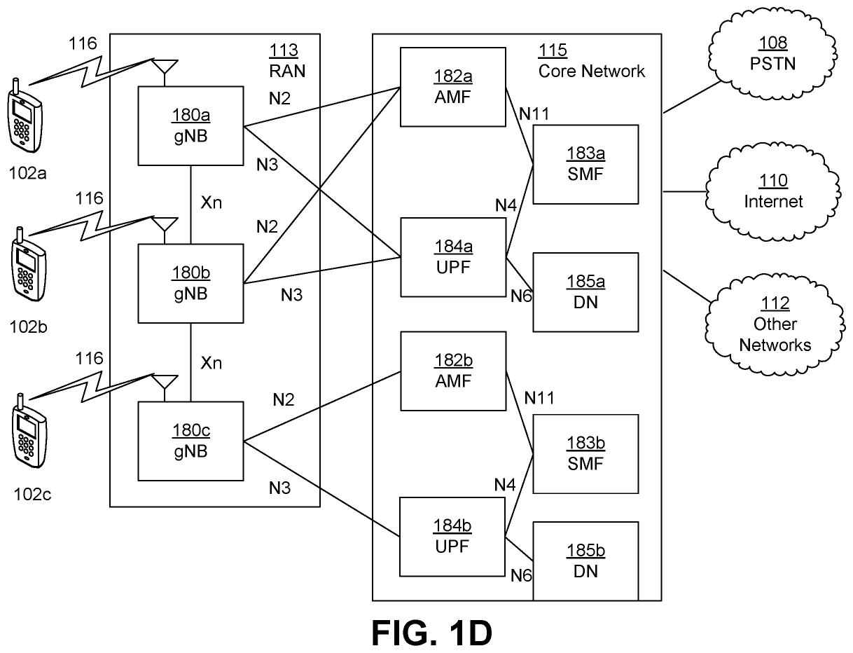

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA,” may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANS, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116,

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor, a geolocation sensor, an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c, and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAS that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operation, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remain idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements is depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

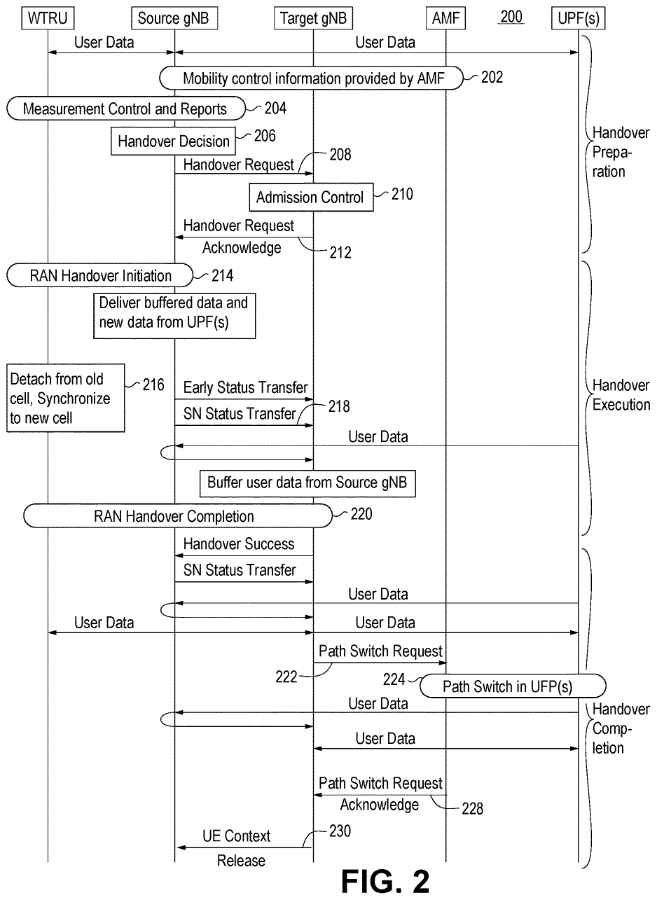

FIG. 2 is a procedure diagram illustrating an example new radio (NR) handover scenario. At 202, an access and mobility access function (AMF) may provide mobility control information. For a WTRU within a source gNB, the provided mobility control information may comprise information regarding roaming and/or access restrictions. The information on roaming and/or access restrictions may be provided to the WTRU at a connection establishment and/or at a timing advance (TA) update.

At 204, the source gNB may configure the WTRU measurement control and report procedures and/or the WTRU may report measurements according to a measurement configuration.

At 206, the source gNB may decide to handover the WTRU based on the reported measurements.

At 208, the source gNB may send a HANDOVER REQUEST message to a target gNB. For example, the source gNB may issue a HANDOVER REQUEST message by passing a transparent RRC container with the necessary information to prepare for the handover at the target side. The necessary information may include at least the target cell ID, KgNB*, the C-RNTI of the WTRU in the source gNB, the RRM-configuration including WTRU inactive time, basic AS-configuration including antenna information and DL carrier frequency, the current QoS flow to DRB mapping rules applied to the WTRU, the SIB1 from source gNB, the WTRU capabilities for different RATs, PDU session related information, and/or the WTRU reported measurement information including beam-related information, if available.

At 210, the target gNB may perform admission control. If the WTRU is to be admitted, the target gNB may prepare the handover with L1/L2.

At 212, the target gNB may send a HANDOVER REQUEST ACKNOWLEDGE message to the source gNB. The HANDOVER REQUEST ACKNOWLEDGE message may include a transparent container to be sent to the WTRU as an RRC message to perform the handover.

At 214, the source gNB may trigger a Uu handover at the WTRU. For example, the source gNB may send an RRCReconfiguration message to the WTRU to initiate the Uu handover. The RRCReconfiguration message may contain the information required to access the target cell. For example, the RRCReconfiguration message may include at least the target cell ID, the new C-RNTI, and/or the target gNB security algorithm identifiers for the selected security algorithms. The RRCReconfiguration message may further include a set of dedicated RACH resources, an association between RACH resources and SSB(s), an association between RACH resources and WTRU-specific CSI-RS configuration(s), common RACH resources, and/or system information of the target cell.

At 216, the source gNB may send an SN STATUS TRANSFER message to the target gNB. The SN STATUS TRANSFER message to the target gNB may convey an uplink PDCP SN receiver status and/or a downlink PDCP SN transmitter status of DRBs for which PDCP status preservation applies (e.g., for RLC AM).

At 218, the WTRU may detach from the old cell (e.g., source gNB) and synchronize to the target cell (e.g., target gNB).

At 220, the WTRU may complete the RRC handover by sending an RRCReconfigurationComplete message to target gNB.

At 222, the target gNB may send a PATH SWITCH REQUEST message to AMF to trigger 5GC. The PATH SWITCH REQUEST message may be sent to trigger 5GC to switch the DL data path towards the target gNB and/or to establish an NG-C interface instance towards the target gNB.

At 224, the 5GC may switch the DL data path toward the target gNB.

At 226, the UPF may send one or more “end marker” packets on the old path to the source gNB per PDU session/tunnel and/or release any U-plane/TNL resources directed towards the source gNB.

At 228, the AMF may confirm the PATH SWITCH REQUEST message with a PATH SWITCH REQUEST ACKNOWLEDGE message.

At 230, upon reception of a PATH SWITCH REQUEST ACKNOWLEDGE message from the AMF, the target gNB may send a UE CONTEXT RELEASE message to inform the source gNB about the success of the handover. The source gNB may release radio and C-plane related resources associated with the WTRU context. Any ongoing data forwarding may continue.

NR Release 16 of 3GPP (R16 ) introduced the concept of conditional handover (CHO) and conditional PSCell Addition/Change (CPA/CPC, collectively referred to as CPAC). Specifically, in CHO, a WTRU may be configured (via an RRC reconfiguration message) with a HO target (e.g., a target cell configuration) and an associated condition in terms of a cell measurement event (e.g., event A3/A5, and corresponding cells). A WTRU, following configuration by the reception of the CHO command, may initiate monitoring of the associated condition. When the condition is satisfied, the WTRU may trigger a HO (e.g., reconfiguration) to the associated cell with the given configuration. Similarly, for CPC and CPA, the WTRU may trigger a PSCell change, or PSCell addition, associated with a stored PSCell configuration upon triggering of an associated condition defined by a measurement event.

In an embodiment, the WTRU may be configured for inter-cell L1/L2 mobility. In NR Release 18 of 3GPP (R18), an objective of the WI “Further NR Mobility Enhancements” in RP-213565 is to specify mechanisms and procedures of L1/L2 based inter-cell mobility for mobility latency reduction. For example, multiple candidate cells may be configured and maintained to allow fast application of configurations for candidate cells [RAN2, RAN3]. Further, candidate serving cells (including SpCell and SCell) may include dynamic switch mechanisms for the potential applicable scenarios based on L1/L2 signaling [RAN2, RAN1]. Further, L1 enhancements for inter-cell beam management are provided, including L1 measurement and reporting and beam indication [RAN1, RAN2]. Early RAN2 involvement may be necessary, including further clarification of the interaction between L1 enhancements for inter-cell beam management and dynamic switch mechanisms among candidate serving cells. Further, timing advance management may be provided [RAN1, RAN2]. Further, CU-DU interface signaling to support L1/L2 mobility may be provided.

In an embodiment, FR2 specific enhancements may not be precluded. In an embodiment, the procedure of L1/L2 based inter-cell mobility may be applicable in multiple scenarios, including standalone, CA and NR-DC cases with a serving cell change within one CG; an Intra-DU case and an intra-CU inter-DU case (e.g., applicable for standalone and CA (e.g., no new RAN interfaces are expected), both intra-frequency and inter-frequency, both FR1 and FR2, and source and target cells that may be synchronized or non-synchronized. The L1/L2 based inter-cell mobility procedure may include an inter-CU.

NR Release 17 of 3GPP (R17 ) included L1/L2 based mobility. In R17, inter-cell beam management addresses intra-DU and intra-frequency scenarios. In these scenarios, the serving cell remains unchanged (e.g., there is no possibility to change the serving cell using L1/L2 based mobility). In FR2 deployments, CA is typically used in order to exploit the available bandwidth (e.g., to aggregate multiple CCs in one band). These CCs are typically transmitted with the same analog beam pair (e.g., gNB and UE beams). The WTRU may be configured with TCI states for the reception of PDCCH and PDSCH. For example, the WTRU may be configured with a fairly large number (e.g., 64) of TCI states. Each TCI state may include an RS or SSB that the WTRU may utilize to set its beam. In R17, the SSB may be associated with a non-serving PCI. MAC signaling (e.g., “TCI state indication for WTRU-specific PDCCH MAC CE”) may activate the TCI state for a Coreset/PDCCH. Reception of PDCCH from a non-serving cell may be supported by a MAC CE message indicating a TCI state associated to a non-serving PCI. MAC signaling (e.g., “TCI States Activation/Deactivation for WTRU-specific PDSCH”) may activate a subset of (e.g., up to) 8 TCI states for PDSCH reception. DCI may indicate which of the 8 TCI states are activated. R17 also supports a “unified TCI state” with a different updating mechanism (e.g., DCI-based) without multi-TRP. R18 supports a unified TCI state with multi-TRP.

An objective of L1/L2 inter-cell mobility may be to improve handover latency. In a conventional or conditional L3 handover, the WTRU typically first sends a measurement report using RRC signaling. In response to the measurement report, the network may provide a further measurement configuration and potentially a conditional handover configuration.

In a conventional L3 handover, the network may provide a configuration for a target cell after the WTRU reports using RRC signaling to indicate that the cell meets a configured radio quality criteria. In a conditional L3 handover, the network may provide a target cell configuration and measurement criteria that determine when the WTRU should trigger the CHO configuration. These criteria may be provided in advance to help reduce the handover failure rate due to a delay in sending the measurement report and/or receiving the RRC reconfiguration. However, conventional or conditional L3 handovers may suffer from some delay due to the sending of measurement reports and the receiving of target configurations, particularly in the case of the conventional (non-conditional) handover.

A particular aim of an L1/L2 based inter-cell mobility configuration may be to allow for fast application of configurations for candidate cells, including dynamically switching between SCells and switching of PCell (e.g., switching the roles between SCell and PCell) without performing RRC signaling. However, this mobility configuration may not apply to inter-CU handovers as these may require relocation of the PDCP anchor. Therefore, an RRC based approach may still be needed to support inter-CU handovers. Moreover, one of the aims of L1/L2 may be to allow CA operation to be enabled instantaneously upon serving cell change.

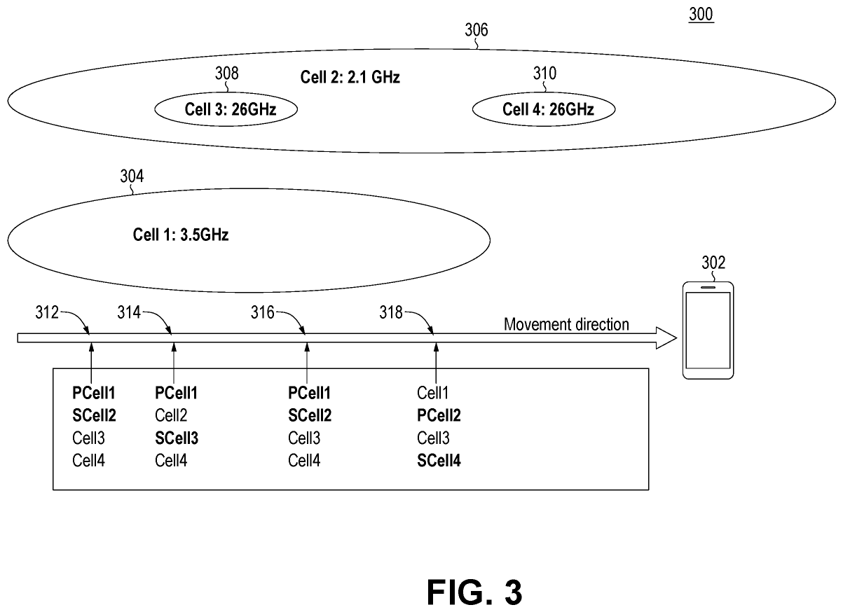

FIG. 3 is a functional model 300 illustrating an example L1/L2 inter-cell mobility operation using CA. In the example operation, the candidate cell group may be configured by RRC and a dynamic switch of PCell and SCell may be achieved using L1/2/signaling.

As shown in the functional model 300, a WTRU 302 may dynamically switch between candidate cells as it physically traverses across a Cell 1 (e.g., 3.5 GHz) 304, a Cell 2 (e.g., 2.1 GHz) 306, a Cell 3 (e.g., 26 GHz) 308, and a Cell 4 (e.g., 26 GHz) 310. At a first position 312, using CA, the WTRU 302 may be initially configured with Cell 1 304 as a primary cell (e.g., PCell 1) and Cell 2 308 as a secondary cell (e.g., SCell 2).

Cells 1-4 304, 306, 308, 310 may initially be configured as candidate cells by an RRC message. Moreover, the RRC message may activate a primary cell and a secondary cell. For example, the RRC message may activate Cell 1 304 as a primary cell and Cell 2 as a secondary cell.

At a second position 314, the WTRU 302 may dynamically switch its secondary cell to Cell 3 308 (e.g., SCell 3). At a third position 316, the WTRU 302 may dynamically switch its secondary cell to Cell 2 306 (e.g., SCell 2). At a fourth position 318, the WTRU 302 may dynamically switch its primary cell to Cell 2 306 (e.g., PCell 2) and its secondary cell to Cell 4 310 (e.g., SCell 4). The candidate cell group within the functional model 300 may be configured by RRC message and dynamic switching of PCells and SCells may be achieved using L1/L2 signaling.

The WTRU may transmit and/or receive a physical channel and/or reference signal according to at least one spatial domain filter. The term “beam” may refer to a spatial domain filter. Herein, spatial domain filter and beam may be used interchangeably.

The WTRU may transmit a physical channel or signal using the same spatial domain filter as the spatial domain filter used for receiving an RS (e.g., such as CSI-RS) or a SS block. The WTRU transmission may be referred to as “target.” The received RS or SS block may be referred to as “reference” or “source.” In such cases, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such cases, the WTRU may be said to transmit the first (e.g., target) physical channel or signal according to a spatial relation with a reference to the second (e.g., reference) physical channel or signal.

A spatial relation may be implicit, configured by RRC, or signaled by MAC CE or DCI. For example, the WTRU may implicitly transmit PUSCH and DM-RS of PUSCH according to the same spatial domain filter. For example, the WTRU may implicitly transmit PUSCH and DM-RS of PUSCH according to the same spatial domain filter as an SRS indicated by an SRI indicated in DCI or configured by RRC. For example, a spatial relation may be configured by RRC for an SRS resource indicator (SRI) or signaled by MAC CE for a PUCCH. Such spatial relation may also be referred to as a “beam indication.”

The WTRU may receive a first (i.e., target) downlink channel or signal according to the same spatial domain filter or spatial reception parameter as a second (i.e., reference) downlink channel or signal. For example, such an association may exist between a physical channel, such as PDCCH or PDSCH, and its respective DM-RS. At least when the first and second signals are reference signals, such an association may exist when the WTRU is configured with a quasi-colocation (QCL) assumption type D between corresponding antenna ports. Such association may be configured as a TCI (transmission configuration indicator) state. In one or more cases, the WTRU may be indicated as an association between a CSI-RS or SS block and a DM-RS by an index to a set of TCI states configured by RRC and/or signaled by MAC CE. Such an indication may also be referred to as a “beam indication.”

The WTRU may be configured to maintain one or multiple beam pairs in a beamformed NR system. The WTRU may monitor certain periodic CSI-RS on a serving DL beam to assess its quality and compute a corresponding quality metric. If the beam quality in a given RS period for all beams in the maintenance set is below a configured threshold, the WTRU's physical (PHY) layer entity may report a beam failure instance (BFI) to the MAC sub-layer.

To reestablish lost beam pair(s) faster than the RLM/RLF procedure, the WTRU may maintain a BFD procedure in which maintained beams are periodically measured. The WTRU may report a beam failure recovery request to the network upon detecting a beam failure. Beam failure recovery (BFR) may be configured for PCell and/or SCell beam maintenance. When BFD and/or DRX are configured in legacy systems, BFD measurements may be taken at the max period of the greater of the DRX and/or CSI-RS periods.

The MAC entity maintains a beam failure instance counter (BFI_counter) for beam failure detection. The MAC entity may count the number of beam failure instance indications received from the PHY layer entity. If the BFI counter exceeds a certain maximum number of BFIs, a BFR request may be triggered to notify the serving gNB that a beam failure has been detected.

The MAC entity may reset the BFI counter after a beam failure detection timer (BFD_timer) has expired. The BFI counter may provide some hysteresis in a detection function. In such cases, the WTRU may reset the BFD timer each time a BFI is indicated. For example, for a BFD timer configured to 3 CSI-RS periods, the MAC entity may reset the BFI counter after observing no BFI indications from the PHY layer for three consecutive CSI-RS periods.

To report a BFR request for a beam failure detected for a PCell and a PSCell (collectively SpCell), the WTRU may initiate a random access (RA) procedure for beam reestablishment. In the random access procedure for beam reestablishment, the WTRU may select an appropriate PRACH preamble and/or PRACH resource dependent on the best measured downlink beam (e.g., CSI-RS or DL SSB). In an embodiment, the WTRU may have means to reestablish a beam pair when the WTRU determines an association between DL beams and/or UL preambles and/or PRACH occasions. The downlink beam selected by the WTRU may be tested by receiving the random access response (RAR) on the downlink beam. Such reestablishment RA procedure may be made faster if the gNB configures a certain set of contention-free PRACH preambles/resources, which may be prioritized for selection by the WTRU upon initiating the reestablishment RA procedure. To report a BFR request for a beam failure detected for the Scell, the WTRU may transmit a MAC CE indicating the cell on which the beam failure was detected.

The WTRU in an RRC_CONNECTED state may continuously monitor its radio link to ensure it is in a good state and/or reliable enough for communication in a process referred to as Radio Link Monitoring (RLM). The WTRU may monitor the downlink (DL) quality based on the reference signal broadcasted from the serving cell.

The WTRU may perform RLM on the Primary Cell (PCell) in a single connectivity operation. The WTRU may perform RLM on both the PCell and the primary cell of the secondary cell group (PSCell) (e.g., SpCell) in a DC operation.

The WTRU may be configured with RLM reference signals (RLM-RS) to monitor and determine the radio quality of the PCell (and the PSCell, in the case of DC). For example, the WTRU may be configured with RLM reference signals (RLM-RS) to monitor and/or determine the radio quality of the PCell in a single link operation. Similarly, the WTRU may be configured with RLM reference signals (RLM-RS) to monitor and/or determine the radio quality of the PSCell in a DC operation. In an embodiment, the network may configure the WTRU to perform the RLM based on SSB (Synchronization Signal Block), CSI-RS (Channel State Information-Reference Signal), and/or a combination of these signal types.

The WTRU may be configured with thresholds to determine whether the monitored radio link is good and/or reliable enough. For example, Qₒᵤₜ may correspond to the level at which the DL cannot reliably be received and/or may correspond to an out-of-sync block error rate (BLERout). The BLERout may be, for instance, a 10% block error rate of a hypothetical PDCCH transmission. For example, Qᵢₙ may correspond to the level at which the DL may be significantly more reliably received than at Qₒᵤₜ and/or correspond to the in-sync block error rate (BLERin). The BLERin may be, for instance, a 2% block error rate of a hypothetical PDCCH transmission.

The WTRU may be configured with timers and/or counters. The WTRU may use the timers and/or counters to determine the reliability of the link that is being monitored. For example, N310 may be the number of consecutive times that an out of sync indication is received at the RRC from lower layers (e.g., PHY) before RRC starts considering the monitored link as experiencing a reliability problem. For example, N311 may be the number of consecutive times that an in-sync indication is received at the RRC from lower layers (e.g., PHY) before RRC considers the monitored link reliable again. For example, T310 may be the duration of the timer started upon N310 consecutive out-of-sync indications received from lower layers and stopped upon N311 consecutive in-sync indications. In an embodiment, if the T310 timer expires before the reception of N311 consecutive in-sync indications from lower layers, then RRC may consider the link failed and/or declare an RLF (Radio Link Failure).

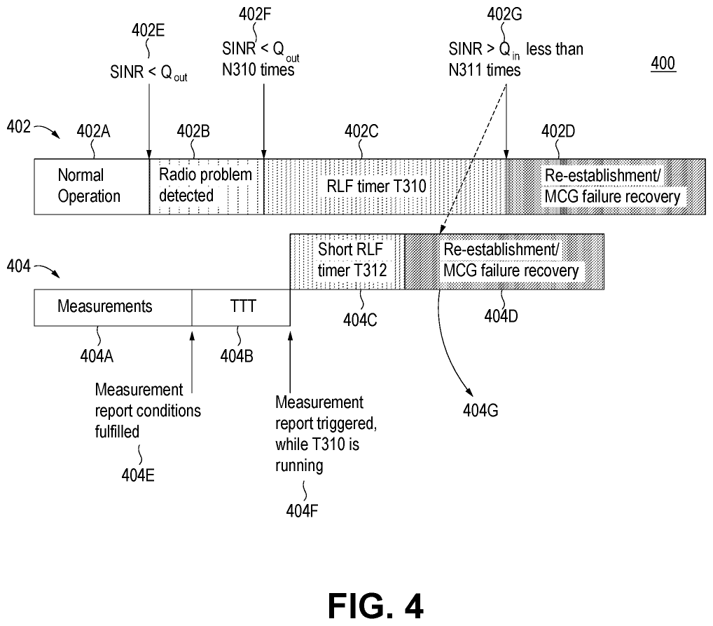

FIG. 4 is a procedure diagram 400 illustrating an example RLM and RLF detection mechanisms. The procedure diagram 400 includes overlapping RLM 402 and radio resource management (RRM) 404 timelines.

The RML timeline 402 may sequentially include a normal operation portion 402A, a radio problem portion 402B, an RLJ timer T310 portion 402C, and a reestablishment/MCG failure recovery portion 402D. For example, the transition from the normal operation portion 402A to the radio problem detected portion 402B may be triggered when a Signal-to-Interference-plus-Noise Ratio (SINR) falls below a defined Qₒᵤₜ level 402E. The transition from the radio problem detected portion 402B to the RLF timer T310 portion 402C may be triggered when the SINR has remained below the defined Qₒᵤₜ level for at least the consecutive number of times configured for N310. The transition from the RLF timer T310 portion 402C to the Reestablishment/MCG failure recovery portion 402D may be triggered when, during the configurated duration of the T310 timer, the SINR has failed to remain above a defined Qin level for the consecutive number of times configured for N311 402G.

The RRM timeline 404 may sequentially include a measurements portion, a Time-to-Trigger (TTT) portion 404B, a short RLF timer T312 portion 404C, and a reestablishment/MCG failure recovery portion 404D. For example, the transition from the measurement portion 404A to the TTT portion 404B may be triggered once the measurement report conditions are fulfilled 404E. The transition from the TTT portion 404B to the short RLF timer T312 portion 404C may be triggered when, during the duration of the T310 timer, the measurement report is triggered 404F. The transition from the RLF timer T312 portion 404C to the Reestablishment/MCG failure recovery portion 404D may be triggered if, by the end of the configurated duration of the T312 timer, the SINR has failed to remain above a defined Qin level for the consecutive number of times configured for N311 404G.

As shown in FIG. 4, the WTRU may employ a T312 timer to detect RLF associated with measurement reporting. A measurement reporting configuration may be associated with the T312 timer. When the reporting conditions are fulfilled and/or a measurement reporting configuration associated with the T312 timer is to be sent, the WTRU may determine whether the T310 timer is already running. The WTRU may determine that the T310 is running when RLM has already identified a problem and is waiting for recovery. If the WTRU determines that the T310 timer is already running, the WTRU may start the T312 timer with its duration set to the configured duration of the T312 timer. If the problem is not resolved before the T312 timer expires, the WTRU may declare an RLF. As such, the WTRU may use the T312 timer to detect a late HO. That is, had the measurement reporting been sent earlier than the radio link problem started, the WTRU may have been handed over to a target cell in time.

In L1/L2 mobility, the WTRU may be prepared by the source cell with the RRC configurations of a set of candidate cells that may be mobility targets (e.g., that can become a PCell or PSCell). Based on beam measurements of the candidate cells, the NW may trigger mobility (e.g., promoting one of the candidate cells to become the PCell or the PSCell) using L1/L2 signaling (e.g., DCI or MAC CE), which has a smaller processing latency compared to L3 signaling.

Using beam measurements to make mobility decisions may allow the network to move the WTRU to the best cell more quickly as compared to longer-term L3 measurements (e.g., RSRP). Moreover, using beam measurements to make mobility decisions may help ensure that the WTRU is always served by the best cell/beam. However, quicker handover decisions may require the WTRU to determine that a candidate cell is not an acceptable target to avoid HO failures due to temporary fades that may occur just prior to mobility. To reduce the latency of the mobility procedure itself, the L1/L2 mobility command may come from the target cell itself.

Beam monitoring/RLM/RLF procedures may be performed on some candidate cells before the handover. However, processing overhead on the WTRU may be a concern if it performs link monitoring on many cells in addition to the serving cell. In an embodiment, the WTRU may be configured to perform RLM/BFD on candidate cells for L1/L2 mobility while limiting the processing/measurement overhead at the WTRU.

Solutions related to RLM/RLF may be applicable to beam failure monitoring/detection. For example, embodiments may relate to procedures at the WTRU for performing RLM and/or detecting or recovering from RLF on a candidate cell in the context of L1/L2 mobility. The same procedures may apply to beam failure monitoring and detection unless indicated otherwise.

RLM and the detection/recovery from RLF on the candidate cells are provided for L1/L2 mobility. The candidate cells may correspond to cells to which the WTRU is prepared to handover to (e.g., as a result of having been preconfigured with the RRC configuration for those candidate cells) as a result of reception of L1/L2 signaling from the network (e.g., beam switch, or reception of a MAC CE indicating the cell to switch to). Such candidate cells may include one or more, or even all, of the candidate serving cells (e.g., SCells) or a subset of the candidate serving cells. In an embodiment, the subset of candidate serving cells may be the serving cells that meet a specific criteria.

In an embodiment, if the WTRU performs RLM and RLF detection/recovery and/or beam failure detection/recovery on candidate target cells, the WTRU/network may be prepared for HO on the candidate target cells. If needed, it may be possible to send the HO command reliably on the target cell. However, the WTRU may be configured with multiple candidate cells (e.g., RRC configurations for potential L1/L2 mobility targets), and as such, monitoring RLM/RLF on all of these may consume significant power at the WTRU.

An L1/L2 mobility and/or handover may refer to making one of the candidate cells the SpCell. In an embodiment, the WTRU may be configured with L1/L2 mobility to perform RLM and/or RLF detection/recovery on candidate target cells.

The WTRU may be configured to perform RLM and RLF detection/recovery on candidate target cells. The WTRU may receive one or more configurations of RLM and RLF detection/recovery associated with the one or more candidate target cells. For example, the WTRU may receive configuration information for RLM of a serving cell and a set of candidate cells. As noted below, the configuration information may include an indication of a time period for RLM of the set of candidate cells. As noted above, the WTRU may receive the configuration information via RRC.

The WTRU may initiate RLM and/or stop RLM on a candidate cell based on one or more, or any combination, of triggers. The triggers may correspond to an explicit or implicit trigger from the network. For example, the WTRU may initiate RLM on a target cell based on explicit signaling, such as a MAC CE providing an index/identifier of the serving cell. The index may be a preconfigured index identifying the target cells. The WTRU may report measurements associated with the candidate cells.

The WTRU may order the reported measurements (e.g., based on RSRP or some other criteria), and the index of the MAC CE initiating the RLM or stopping RLM may correspond to the index in the list reported by the WTRU in the last measurement. For example, the WTRU may receive a MAC CE containing a bitmap where each bit in the bitmap corresponds to a candidate cell, and a value of ‘1’ indicates to perform RLM on that serving cell, while a value of ‘0’ indicates not performing RLM on that serving cell. For example, the WTRU may receive an L1/L2 HO command to switch to one of the candidate cells. Receiving the L1/L2 HO command may implicitly initiate RLM on the received candidate cell. Receiving the L1/L2 HO command may also implicitly initiate RLM on another candidate cell and/or implicitly stop RLM on another candidate cell.

The WTRU may receive a message that indicates that RLM is to be initiated on a subset of the set of candidate cells using the configuration information for the RML for the set of candidate cells indicated in an RRC message.

A trigger may correspond to a condition associated with the measured quality of the SpCell, and/or another candidate cell. For example, the WTRU may initiate RLM on a candidate cell when the RSRP of the SpCell is below a threshold. The WTRU may initiate RLM on a candidate cell when the RSRP of the SpCell is below a threshold for a time period. For example, the WTRU may stop RLM on a candidate cell where RLM is ongoing when the RSRP of the serving cell is above a threshold. The WTRU may stop RLM on a candidate cell where RLM is ongoing when the RSRP of the serving cell is above a threshold for a time period.

The WTRU may determine to perform RLM on the subset of the set of candidate cells for at least the time period defined in the configuration information after receiving the message.

The WTRU may report the best N candidate cells to the network. Upon providing such a report, the WTRU may stop RLM on any candidate cells not part of the N reported candidate cells. The WTRU may determine to report at L2/L2 measurements associated with the RLM performed on the subset of candidate cells.

A trigger may correspond to a condition associated with the measured quality of the candidate cell. For example, the WTRU may initiate RLM on a candidate cell when the RSRP of the candidate cell is itself above a threshold. For example, the WTRU may initiate RLM on a candidate cell when the RSRP of the candidate cell is itself above a threshold for a time period.

The WTRU may stop RLM on a candidate cell when the RSRP on the candidate cell is below a threshold. The WTRU may stop RLM on a candidate cell when the RSRP on the candidate cell is below a threshold for a time period. The WTRU may determine to terminate RLM on the subset of the set of candidate cells once the time period defined in the configuration after receiving the message has passed.

The WTRU may perform a relaxed RLM on a candidate cell when the RSRP of the candidate cell is between a first threshold and a second threshold.

The WTRU may initiate RLM on the top N best candidate cells in which N is configurable.

A trigger may correspond to a condition associated with the current RLM status of the SpCell, or another candidate cell. For example, the WTRU may initiate RLM on a candidate cell when a condition related to the status of the RLM of the SpCell is met.

The WTRU may initiate RLM on a candidate cell when the T310 timer has started and/or is running on the SpCell.

The WTRU may stop the RLM of a candidate cell initiated by a start of the T310 timer on the SpCell when the T310 timer is stopped on the SpCell (e.g., due to the SpCell going back into sync) and/or after a period in which the T310 timer is stopped. Similarly, the WTRU may stop the RLM of a candidate cell initiated by a start of the T310 timer on the SpCell when the T310 timer is stopped on the SpCell (e.g., due to the SpCell going back into sync). The WTRU may stop the RLM of a candidate cell initiated by a start of the T310 timer on the SpCell after a period in which T310 is stopped.

A trigger may correspond to a condition associated with the beam failure detection on a SpCell. For example, the WTRU may initiate RLM on a candidate cell after detecting a beam failure on the SpCell. The WTRU may initiate RLM on a candidate cell after detecting a certain number of beam failures within a given time period. A trigger may correspond to a condition associated with an amount of time since the occurrence of another trigger.

The WTRU may report RLF of candidate target cells. The WTRU may report RLF of one or more candidate cells. For example, the WTRU may use a MAC CE to report the occurrence of RLF on one or more candidate cells. The WTRU may use a bitmap (e.g., a bitmap with one bit representing each of the configured candidate cells) to report RLF on multiple candidate cells.

The WTRU may send an RLF report upon the occurrence of an RLF triggered on any candidate cell. The WTRU may be configured with the condition that determines when to report RLF on one or more candidate cells. The condition may correspond to the number of candidate cells and/or the ratio of candidate cells that have experienced RLF. For example, the WTRU may send an RLF report when RLF has been detected on at least X candidate cells, in which X may be a configured number. For example, the WTRU may send an RLF report when RLF has been detected on a certain percentage of the candidate cells that have RLM activated. The condition may correspond to a similar event related to the monitoring of RLM. For example, the WTRU may monitor RLM on the candidate cells and/or report RLF related to the candidate cells when the RSRP of SpCell is below a threshold.

The WTRU may determine to perform RLM on the subset of the set of candidate cells for at least the time period defined in the configuration information after detecting the RLF on the serving cell. The WTRU may determine to terminate RLM on the subset of the set of candidate cells once the time period after detecting the RLF on the serving cell has passed. The WTRU may determine to perform RLM based on the detected RLF of the serving cell on a target candidate cell from within the subset of the set of candidate cells in accordance with the configuration information for the RLM for the serving cell. An RLF may not have been detected on the target candidate cell.

The WTRU may be configured to perform a relaxed RLM on candidate target cells. For example, a relaxed RLM on candidate cells may include reporting in specification/out-of-specification (IS/OOS) results less frequently than a regular RLM. The relaxed RLM may include monitoring RSs for RLM less frequently than SpCell's RLM.

The WTRU may be configured with conditions as to when to perform normal RLM or relaxed RLM on candidate cells. Such conditions may be similar to those for initiating RLM on candidate cells. For example, the WTRU may be configured with an RSRP threshold on the current SpCell. For example, if the SpCell quality is above a threshold, the WTRU may perform a relaxed RLM on a number of candidate cells. If the SpCell quality is below a threshold, the WTRU may perform normal RLM on the candidate cells.

The WTRU may be configured with relaxed detection of RLF on the candidate cells compared to the regular RLF detection on the SpCell. For example, the WTRU may be configured with N310, N311, and T310 associated with the SpCell. The WTRU may be configured to scale up the values of N310 and T310 and/or scale down the value of N311 to determine the counter values and/or timer values to use for RLF detection for a candidate cell. For example, the WTRU may be configured with a less frequent RLM monitoring on candidate cells.

The L1/L2 handover procedure/behavior may depend on whether the WTRU is performing RLM on a candidate cell during the L1/L2 handover. For example, the WTRU may be instructed to perform an L1/L2 handover to a cell. The WTRU may or may not have initiated an RLM procedure to perform the L1/L2 handover to a cell. The WTRU may perform different operations for the L1/L2 handover based on whether the WTRU performed RLM on the concerned candidate cell before the handover command.

Whether or not RLM was performed on a candidate cell before the handover may affect the handling of the RLF timer/counters. A determination of whether to reset RLF counters and/or stop the RLF timers and/or maintain current counter values and keep the RLF timer running (e.g., for the cases in which the RLF timer was running) at the HO, may depend on whether RLM was being performed on the chosen candidate cell before the handover. For example, if RLM was performed on the candidate cell, the WTRU may not reset RLF timers/counters on the cell at HO. If RLM was not performed on the candidate cell, any RLF timers/counters may be stopped/reset at HO for that cell. Moreover, if RLM was being performed at other candidate cells, the WTRU may be configured not to reset the RLF counters and/or not to reset the RLF timers concerning those candidate cells.

The WTRU may send a confirmation to a HO command (e.g., a MAC CE confirmation message) if RLM was not performed before the HO. If RLM was being performed at HO, the WTRU may be configured to not send the confirmation.

The WTRU may report RLF results (e.g., reporting the RLF results of other candidate cells) on other candidate target cells at the time of HO (e.g., in the HO complete message), for example, if the WTRU is performing RLM on the candidate cell at the time of HO to the candidate cell.

The WTRU may be configured to report cell quality (e.g., CQI) upon reception of HO. For example, the WTRU may be configured to report cell quality (e.g., CQI) upon reception of HO if the WTRU is not performing RLM on the candidate cell. If the WTRU is performing RLM on the candidate cell, the WTRU may be configured to not report cell quality.

The WTRU may be configured to perform a more intense (e.g., more frequent) reporting of UL quality at HO based on whether RLM was being performed on the cell at the time of HO.

The WTRU may autonomously trigger L1/L2 handover upon triggers related to the RLM/RLF and/or BFD. The WTRU may perform L1/L2 handover to a candidate target cell based on a trigger related to RLF and/or BFD. For example, the WTRU may perform L1/L2 handover to a candidate cell if RLF is triggered on the current SpCell. If the L1/L2 HO triggered by RLF on the SpCell fails, the WTRU may perform an L3 recovery procedure (e.g., reestablishment). For example, the WTRU may perform L1/L2 handover to a candidate cell if a beam failure is detected on the SpCell. If L1/L2 HO triggered by beam failure detection on the SpCell fails, the WTRU may be configured to perform a beam failure recovery procedure. For example, the WTRU may perform L1/L2 handover to a candidate cell if a condition related to RLF, such as T310, is started on the SpCell. If L1/L2 HO triggered by starting T310 fails, the WTRU may be configured to continue to run T310 and/or trigger L3 recovery (e.g., reestablishment) if T310 expires.

The WTRU may receive a handover command (e.g., L1/L2) towards a first candidate cell from the subset of the set of candidate cells.

The WTRU may further trigger L1/L2 handover upon any of the above triggers based on certain conditions related to the candidate cells. For example, if a condition related to the candidate cell(s) (e.g., the cell to which the WTRU selects to perform the L1/L2 handover) is satisfied, the WTRU may be configured to perform L1/L2 HO. If the condition related to the candidate cell(s) is not satisfied, the WTRU may perform an L3 recovery procedure (e.g., reestablishment) or a legacy recovery procedure (e.g., beam failure recovery).

These conditions may include any combination of the following conditions. For example, a condition may correspond to scenarios in which the WTRU is monitoring RLM on at least one candidate cell. In this instance, the WTRU may select a candidate cell on which to perform L1/L2 mobility at the time of the trigger. For example, a condition may correspond to at least one candidate cell having cell quality (e.g., RSRP) above a threshold. In this instance, the WTRU may select a candidate cell on which to perform L1/L2 mobility at the time of the trigger. For example, a condition may correspond to the WTRU monitoring RLM on at least one candidate cell where RLF has not yet been triggered, or T310 has not been started. For example, a condition may correspond to the WTRU performing beam measurements on at least one candidate cell, and the WTRU may determine that the beam measurements are better than a threshold.

The WTRU may be configured to perform reestablishment (e.g., when the WTRU triggered L1/L2 mobility has failed) on one of the candidate cells on which the WTRU is already performing RLM. The WTRU may be configured to indicate to the network information regarding the decision to perform the WTRU triggered L1/L2 mobility. The information may further include measurements of the previous SpCell, current SpCell, other candidate cells, and/or other similar types of measurements.

One or more WTRU behaviors described herein may be combined to define the WTRU's behavior related to RLM/RLF before and/or after the reception of an L1/L2 HO command.

The WTRU may be configured to receive an RRC configuration for a set of candidate cells. The WTRU may be configured to perform beam measurements of all candidate cells. Alternatively or additionally, the WTRU may be configured to perform beam measurements on a subset of the candidate cells.

The WTRU may receive a MAC CE that initiates RLM and/or beam measurements on a subset of the candidate cells. The WTRU may be configured to order the candidate cells based on the last measured/reported RSRP.

The WTRU may be configured to receive a MAC CE organized as a bitmap of the best X candidate cells reported. The bitmap may indicate whether to initiate and/or stop RLM on each of the best candidate cells.

The WTRU, upon initiation of RLM, may initiate and/or perform RLM on the indicated candidate cells using a relaxed RLM configuration (e.g., less frequent RS measurements) upon reception of a MAC CE.

The WTRU may reset the RLF counters and/or stop RLF timers associated with the candidate cells indicated to be monitored. The WTRU may be configured to continue performing RLM for a configured time period following the reception of the MAC CE. The WTRU may continue to perform RLM on the candidate cells as long as the serving cell RSRP is below a threshold upon the expiration of the timer.

The WTRU may, during RLM performance on the candidate cells, report to the network using a MAC CE any cell in which RLF is triggered. The WTRU may be configured to stop RLM on that candidate cell until the cell is reconfigured. The WTRU may remove the cell from the list of cells reported for measurements by the WTRU.

If L1 HO is performed to a candidate cell, the WTRU may stop performing relaxed RLM to that candidate cell (e.g., relaxed RLM is being performed on the candidate cell). For example, the WTRU may be configured to start normal (i.e., non-relaxed) RLM, as it is the new SpCell. For example, the WTRU may immediately stop RLM on all candidate cells previously indicated by the NW MAC CE.

The WTRU may be configured with a set of candidate cells via RRC. The WTRU may be configured to receive a MAC CE indicating a subset of the candidate cells, which may serve as early RLM targets. The WTRU may initiate RLM on the candidate cells identified by the MAC CE upon starting T310 on the SpCell. The identification of the candidate cells may be performed using other examples as described herein.

The WTRU, if RLF is triggered on the SpCell, may perform L1/L2 HO to a candidate cell provided the candidate cell has RLM running and RLF was not yet been triggered. If no such candidate cell is found, the WTRU may be configured to trigger an L3 recovery procedure following RLF on the serving cell (e.g., reestablishment).

The WTRU may be configured to perform RLM on a candidate cell even after RLF is detected. For example, the WTRU may be configured to keep counting the number of RLF instances detected on the candidate cell. The number of RLF instances detected on the candidate cell may be later reported to the network. For example, the number of RLF instances detected on the candidate cell may be later reported to the network upon the next L1/L2 HO. For example, the number of RLF instances detected on the candidate cell may be later reported to the network when a certain number of RLFs have been detected within a given time period. The WTRU may be configured to stop performing RLM on a candidate cell if more than a certain number of RLFs are detected within a given time period.

The WTRU may determine to perform RLM on the first candidate cell in accordance with the configuration information for the RLM for the serving cell based on receiving the handover command.

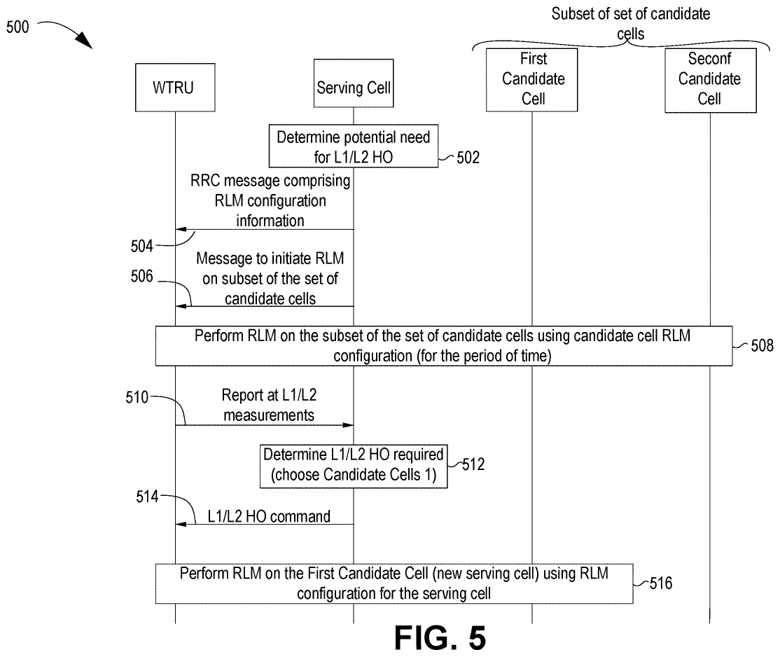

FIG. 5 is a diagram illustrating an example call flow 500 of L1/L2 inter-cell mobility operation based on L1/L2 measurements. The call flow 500 is an example of the processes and procedures described above. The call flow 500 relates to a WTRU's behavior related to RLM/RLF before and/or after the reception of an L1/L2 HO command.

At 502, a serving cell may be configured to determine a potential need for an L1/L2 handover by the WTRU. At 504, the WTRU may receive a message (e.g., an RRC message) from the serving cell that includes configuration information for RLM of the serving cell and a set of candidate cells. The configuration information may comprise an indication of a time period for RLM of the set of candidate cells. In some examples, the configuration information may include a reference signal received power (RSRP) threshold for the serving cell.

At 506, the WTRU may receive a message from the serving cell that indicates that RLM is to be initiated on a subset of the candidate cells using the configuration information for the RLM for the set of candidate cells indicated in the RRC message. The message may be an L2 control message, such as a MAC CE.

At 508, the WTRU may determine to perform RLM on the subset of the set of candidate cells for at least the time period after receiving the message. For instance, in some examples, the WTRU may determine to terminate RLM on the subset of the set of candidate cells once the time period after receiving the message has passed. Further, in some examples, the WTRU may determine to perform RLM for the subset of the set of candidate cells beyond the time period after receiving the message based on a measured serving cell RSRP being below the RSRP threshold for the serving cell (e.g., where the RSRP threshold is provided via the configuration information). At 510, the WTRU may determine to report at L1/L2 measurements associated with the RLM performed on the subset of the set of candidate cells.

At 512, the serving cell may determine that a handover is required. The determination of the handover may be made based on L1/L2 measurements of the subset of candidate cells received from the WTRU. The handover may be an L1/L2 handover. As shown in FIG. 5, the serving cell may choose the first candidate cells from the subset of the set of candidate cells as the target of the handover.

At 514, the WTRU may receive a handover command from the serving cell towards a target candidate cell from the subset of the set of candidate cells. As shown in FIG. 5, the handover command may identify the first candidate cell as the target candidate cell. The handover command may be for an L1/L2 handover command.

At 516, the WTRU may determine to perform RLM on the first candidate cell in accordance with the configuration information for the RLM for the serving cell based on receiving the handover command.

The WTRU may determine an L1/L2 inter-cell mobility operation based on a detected RLF of a candidate cell. For example, while performing RLM on the subset of the set of candidate cells for at least the time period after receiving the message, the WTRYU may detect and report an RLF of the first candidate cell associated with the RLM of the subset of the set of candidate cells. The WTRU may receive a handover command from the serving cell towards a target candidate cell from the subset of the set of candidate cells. The handover command may identify a second candidate cell as the target candidate cell. The WTRU may determine to perform RLM on the second candidate cell in accordance with the configuration information for the RLM for the serving cell based on receiving the handover command.

The WTRY may determine an L1/L2 inter-cell mobility operation based on a detected RLF of a serving cell. For example, while performing RLM on the subset of the set of candidate cells for at least the time period after receiving the message, the WTRU may detect an RLF on the serving cell. The WTRU may determine to perform RLM on the subset of the set of candidate cells using the configuration information for RLM for at least the time period after detecting the RLF on the serving cell. The WTRU may determine to terminate RLM on the subset of the set of candidate cells once the time period after detecting the RLF on the serving cell has passed. The WTRU may determine to perform RLM on a target candidate cell (new serving cell) using RLM configuration for a serving cell. The determination to perform RLM may be based on the detected RLF of the serving cell. An RLF of the target candidate cell may not have been detected.

What is claimed is:

1. A wireless transmit/receive unit (WTRU) comprising:
a processor configured to:
receive a radio resource control (RRC) message comprising configuration information for radio link monitoring (RLM) of a serving cell and a set of candidate cells, the configuration information comprising an indication of a time period for RLM of the set of candidate cells;
receive a message that indicates that RLM is to be initiated on a subset of the set of candidate cells using the configuration information;
determine to perform RLM on the subset of the set of candidate cells for at least the time period after receiving the message;
determine to terminate RLM on the subset of the set of candidate cells once the time period after receiving the message has passed;
determine to report layer 1 or layer 2 (L1/L2) measurements associated with the RLM performed on the subset of the set of candidate cells;
receive a handover command indicating a first candidate cell from the subset of the set of candidate cells; and
determine to perform RLM on the first candidate cell in accordance with the configuration information for the RLM for the serving cell based on receiving the handover command.

2. The WTRU of claim 1, wherein the handover command is an L1/L2 handover.

3. The WTRU of claim 1, wherein the configuration information further comprises a reference signal received power (RSRP) threshold for the serving cell; and
wherein the processor is further configured to determine to perform RLM for the subset of the set of candidate cells beyond the time period after receiving the message based on a measured serving cell RSRP being below the RSRP threshold for the serving cell.

4. The WTRU of claim 1, wherein the message is an L2 control message.

5. The WTRU of claim 4, wherein the message is a medium access control (MAC) control element (MAC CE).

6. The WTRU of claim 1, wherein the processor is further configured to:
detect a radio link failure (RLF) on the first candidate cell; and
determine to perform RLM on a second candidate cell in accordance with the configuration information for the RLM for the serving cell based on receiving the L1/L2 handover command.

7. The WTRU of claim 6, wherein the processor is further configured to determine to report the RLF of the first candidate cell.

8. The WTRU of claim 1, wherein the processor is further configured to:
detect a radio link failure (RLF) on the serving cell;
determine to perform RLM on the subset of the set of candidate cells for at least the time period after detecting the RLF on the serving cell;
determine to terminate RLM on the subset of the set of candidate cells once the time period after detecting the RLF on the serving cell has passed; and
determine to perform RLM based on the detected RLF of the serving cell on a target candidate cell from within the subset of the set of candidate cell in accordance with the configuration information for the RLM for the serving cell, wherein RLF of the target candidate cell has not been detected.

9. The WTRU of claim 1, wherein the RLM performed on the subset of the set of candidate cells is a relaxed RLM.

10. A method performed by a wireless transmit/receive unit (WTRU), the method comprising:
receiving a radio resource control (RRC) message comprising configuration information for radio link monitoring (RLM) of a serving cell and a set of candidate cells, the configuration information comprising an indication of a time period for RLM of the set of candidate cells;
receiving a message that indicates that RLM is to be initiated on a subset of the set of candidate cells using the configuration information;
determining to perform RLM on the subset of the set of candidate cells for at least the time period after receiving the message;
determining to terminate RLM on the subset of the set of candidate cells once the time period after receiving the message has passed;
determining to report layer 1 or layer 2 (L1/L2) measurements associated with the RLM performed on the subset of the set of candidate cells;
receiving a handover command indicating a first candidate cell from the subset of the set of candidate cells; and
determining to perform RLM on the first candidate cell in accordance with the configuration information for the RLM on the serving cell based on receiving the L1/L2 handover command.

11. The method of claim 10, wherein the handover command is an L1/L2 handover.

12. The method of claim 10, wherein the configuration information further comprises a reference signal received power (RSRP) threshold for the serving cell, the method further comprising:
determining to perform RLM for the subset of the set of candidate cells beyond the time period after receiving the message based on a measured serving cell RSRP being below the RSRP threshold for the serving cell.

13. The method of claim 10, wherein the message is an L2 control message.

14. The method of claim 13, wherein the message is a medium access control (MAC) control element (MAC CE).

15. The method of claim 10, further comprising:
detecting a radio link failure (RLF) on the first candidate cell; and
determining to perform a handover procedure to a second candidate cell within the subset of the set of candidate cells based on the RLF detected on the first candidate cell.

16. The method of claim 15, further comprising reporting the RLF of the first candidate cell.

17. The method of claim 10, further comprising:
detecting a radio link failure (RLF) on the serving cell;
determining to perform RLM on the subset of the set of candidate cells for at least the time period after detecting the RLF on the serving cell;
determining to terminate RLM on the subset of the set of candidate cells once the time period after detecting the RLF on the serving cell has passed; and
determining to perform RLM based on the detected RLF of the serving cell on a target candidate cell from within the subset of the set of candidate cell in accordance with the configuration information for the RLM for the serving cell, wherein RLF of the target candidate cell has not been detected.

18. The method of claim 10, wherein the RLM on the subset of the set of candidate cells is a relaxed RLM.
